(19) United States
(12) Patent Application Publication
(10) Pub. No.: US 2009/0223164 A1
(43) Pub. Date: Sep. 10, 2009

(54) VERTICAL ROTATING AERODYNAMIC TOWER

(75) Inventors: Bradley J. Cook, Boulder, CO (US); Dan J. Welch, Boulder, CO (US)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: STRUCTURAL COMPONENTS LLC, Boulder, CO (US)

(21) Appl. No.: 12/400,575

(22) Filed: Mar. 9, 2009

Related U.S. Application Data
(60) Provisional application No. 61/034,914, filed on Mar. 7, 2008.
(60) Provisional application No. 61/039,084, filed on Mar. 24, 2008.

(51) Int. Cl. E04H 12/02; H01Q 1/12; E06C 1/00; E04H 12/18

(52) U.S. Cl. 52/651.07; 343/891; 182/194

(57) ABSTRACT

A tower according to embodiments of the present invention includes a monopole shell having a vertical axis, the vertical axis substantially aligned with a gravitational force, wherein at least a portion of the monopole shell has an aerodynamic shape, wherein an outer perimeter of the aerodynamic shape comprises a leading edge and a trailing edge, wherein a chord between the leading edge and the trailing edge is shorter than a distance along the outer perimeter between the leading edge and the trailing edge, and wherein a maximum dimension of the outer perimeter measured orthogonally to the chord and the vertical axis is shorter than the chord; and a base, wherein the monopole shell rotates about the vertical axis with respect to the base.

### CROSS-REFERENCE TO RELATED APPLICATIONS

This application claims the benefit of U.S. Provisional Patent Application Ser. No. 61/034,914, filed on Mar. 7, 2008, and also claims the benefit of U.S. Provisional Patent Application Ser. No. 61/039,084, filed on Mar. 24, 2008, both of which are incorporated by reference herein in their entirety for all purposes.

### TECHNICAL FIELD

Embodiments of the present invention relate generally to tower structures, and more specifically to monopole structures with reduced air drag.

### BACKGROUND

Current monopole structures often have an outer surface with a circular or polygonal cross section. Such a cross section often leads to a high drag coefficient, and thus a higher loading force for a given wind velocity. Such a high drag coefficient often requires stronger and heavier materials and/or foundations to withstand wind loading.

### SUMMARY

Monopoles according to embodiments of the present invention include a base structure, and an aerodynamic shell structure mounted to a shaft. According to some embodiments of the present invention, the aerodynamic shell structure houses one or more antennae. According to other embodiments of the present invention, the aerodynamic shell structure rotates about a shaft according to the direction of the wind, such that the leading edge of the aerodynamic shell structure orients itself against the prevailing wind, the shaft being rigidly coupled to the base structure. The aerodynamic shell structure may include a ladder and/or be constructed with dimensions sufficient to permit a person to ascend the inside of the aerodynamic shell structure.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a front perspective view of an aerodynamic monopole according to embodiments of the present invention.

FIG. 2 illustrates a front perspective view of the aerodynamic monopole of FIG. 1 with a transparent outer shell, according to embodiments of the present invention.

FIG. 3 illustrates a side cross sectional elevation view of the aerodynamic monopole of FIGS. 1 & 2, according to embodiments of the present invention.

FIG. 4 illustrates a top view of the aerodynamic monopole of FIGS. 1-3, according to embodiments of the present invention.

FIG. 5 illustrates a side elevation view of an aerodynamic monopole, according to embodiments of the present invention.

FIG. 6 illustrates an enlarged partial sectional view of the aerodynamic monopole of FIG. 5, according to embodiments of the present invention.

FIG. 7 illustrates an outer perimeter of an aerodynamic monopole, according to embodiments of the present invention.

FIG. 8 illustrates a cross-sectional view of an aerodynamic monopole with an enlarged partial cross-sectional view, according to embodiments of the present invention.

FIG. 9 illustrates another cross-sectional view of an aerodynamic monopole, according to embodiments of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

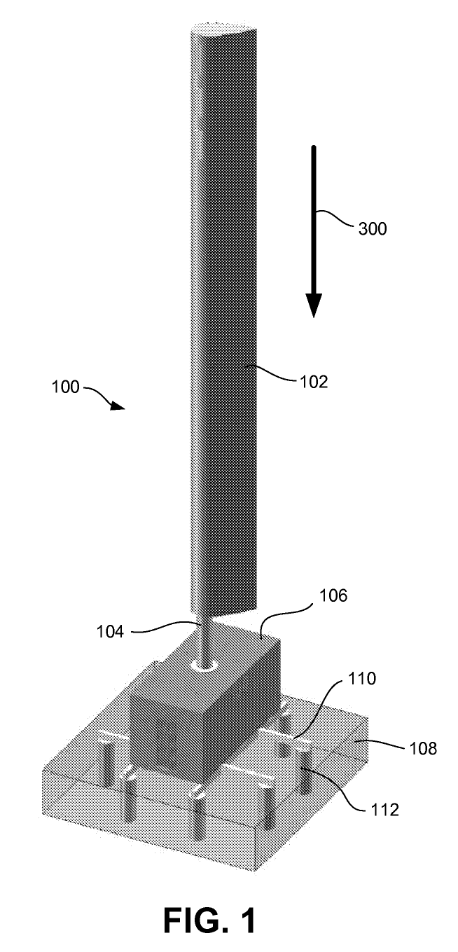

FIG. 1 illustrates a front perspective view of an aerodynamic monopole 100 according to embodiments of the present invention. Aerodynamic monopole 100 includes an aerodynamic shell structure 102, a shaft 104, and a base structure 106, according to embodiments of the present invention. The aerodynamic shell structure 102 includes a vertical axis that is substantially aligned with the force of gravity, represented by arrow 300. The shaft 104 also includes a central axis, which is substantially aligned with the vertical axis of the shell structure 102 and about which the shell structure rotates with respect to the shaft 104 and the base structure 106. The base structure 106 is mounted on horizontal support beams 110 and/or caisson footing 112 on or within the ground 108 or other underlying surface, according to embodiments of the present invention. The aerodynamic monopole may also be connected directly to a large caisson, a spread-footing, or any other foundation design to resist overturning moments. According to some embodiments of the present invention, the aerodynamic monopole 100 extends to one hundred feet above ground level; according to other embodiments of the present invention, the aerodynamic monopole 100 extends to two hundred or more feet above ground level.

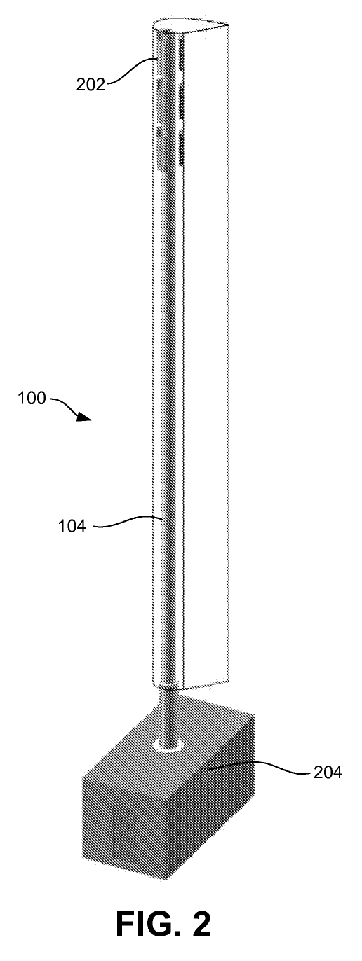

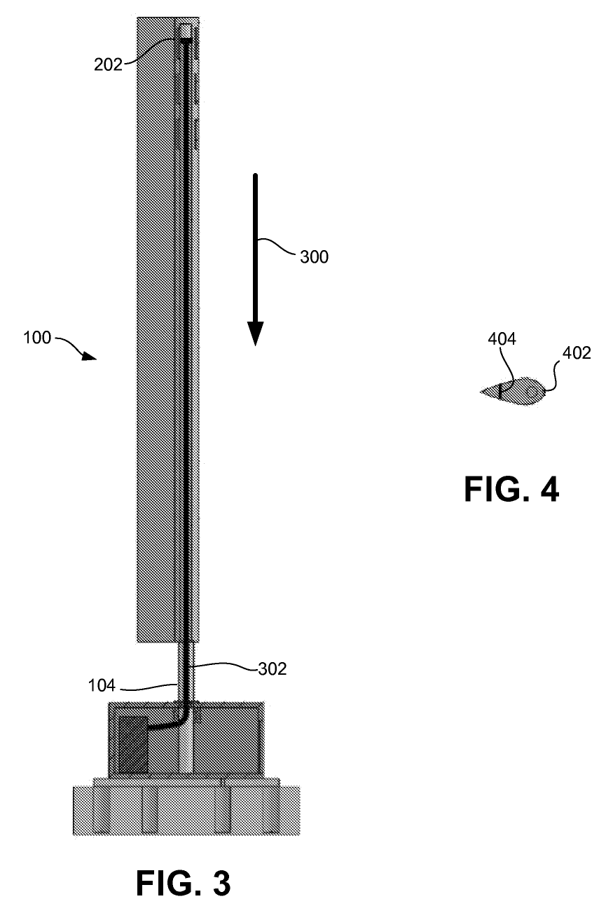

FIG. 2 illustrates a front perspective view of the aerodynamic monopole 100 with a transparent outer shell, revealing antennae 202 and inner shaft 104, according to embodiments of the present invention. FIG. 3 illustrates a side cross sectional elevation view of the aerodynamic monopole 100, according to embodiments of the present invention. Antennae 202 may be mounted within the aerodynamic shell structure 102, according to embodiments of the present invention. As such, mounting additional antennae 202 inside of the aerodynamic shell structure 102 does not increase the drag coefficient or the corresponding wind loading of the monopole 100. An aerodynamic shell structure 102 with a substantially hollow interior permits a wide variety of AM pipe or tower antenna masts, FM, UHF, and/or cellular antennae, electronics, and/or other equipment to be mounted within the aerodynamic shell structure 102 while preserving a simple and aesthetically pleasing appearance for the aerodynamic monopole 100. Using an aerodynamically-shaped structure 102 with a long chord length also increases banner or advertising space on an aerodynamic monopole 100 without adding additional wind drag, according to embodiments of the present invention. The base structure 106 may also include ports 204 to add additional shelter space.

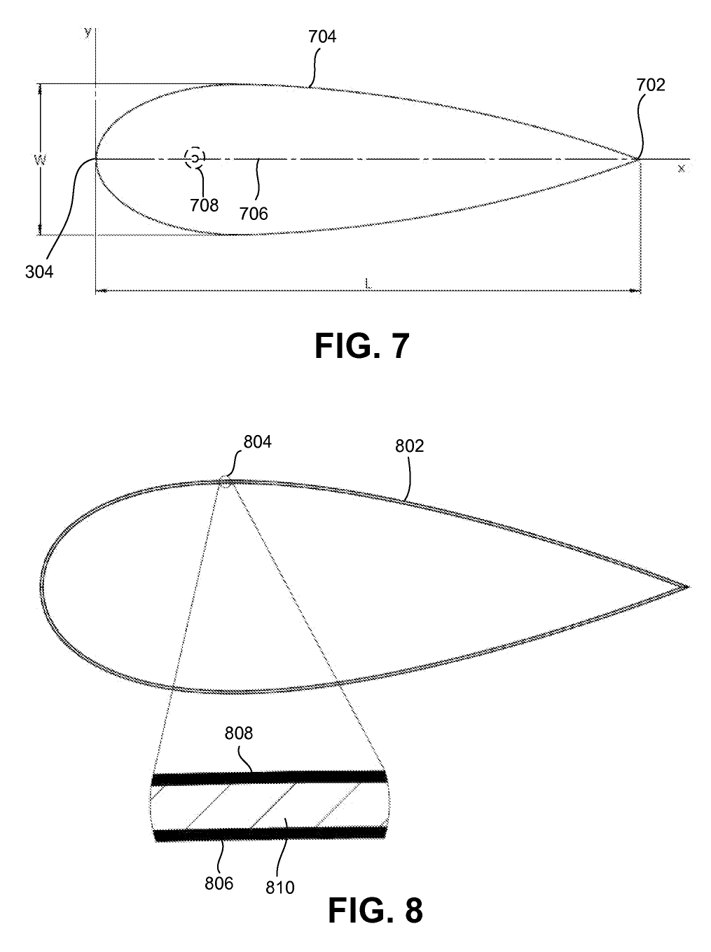

According to some embodiments of the present invention, the aerodynamic shell structure 102 rotates about a shaft 104 according to the direction of the wind, such that the leading edge 304 of the aerodynamic shell structure (as seen in FIGS. 4 and 7) orients itself against the prevailing wind, the shaft 104 being rigidly coupled to the base structure 106. According to other embodiments of the present invention, the aerodynamic shell structure 102 is rigidly coupled with the shaft 104, and the shaft 104 rotates within the base structure 106 to permit the leading edge 304 of the aerodynamic shell structure 102 to orient itself into the prevailing wind. According to yet other embodiments, the aerodynamic shell structure 102 rotates about the shaft 104 and the shaft 104 also rotates with respect to the base 106. The aerodynamic shell structure 102 may include a ladder 404 and/or be constructed with dimensions sufficient to permit a person to ascend the inside of the aerodynamic shell structure 102.

According to some embodiments of the present invention, the shaft 104 is substantially or partially hollow, and a coaxial or other cable or wire 302 may be inserted from the base, through the shaft 104 and extend up to the antennae 202 nearer the top of the monopole 100, as illustrated in FIG. 3. According to some embodiments of the present invention, the aerodynamic shell structure 102 orients itself according to the prevailing wind by rotating to the position of least wind drag (e.g. the position with the leading edge 304 oriented toward the prevailing wind) similar to a weather vane. According to other embodiments of the present invention, a motor or other mechanical assembly is used to rotate the aerodynamic shell structure 102 and/or the shaft 104. The motor or other mechanical assembly may be used to rotate the aerodynamic shell structure 102 and/or the shaft 104 to a position in which the leading edge 304 is oriented toward the prevailing wind based on a wind direction sensor, according to embodiments of the present invention. An advertisement or other visual information or display may be formed on the side and/or top of the aerodynamic shell structure 102, according to embodiments of the present invention. In such cases, the motor or other mechanical assembly may be used to rotate the aerodynamic shell structure 102 according to a pre-programmed and/or random display or advertising orientation, according to embodiments of the present invention.

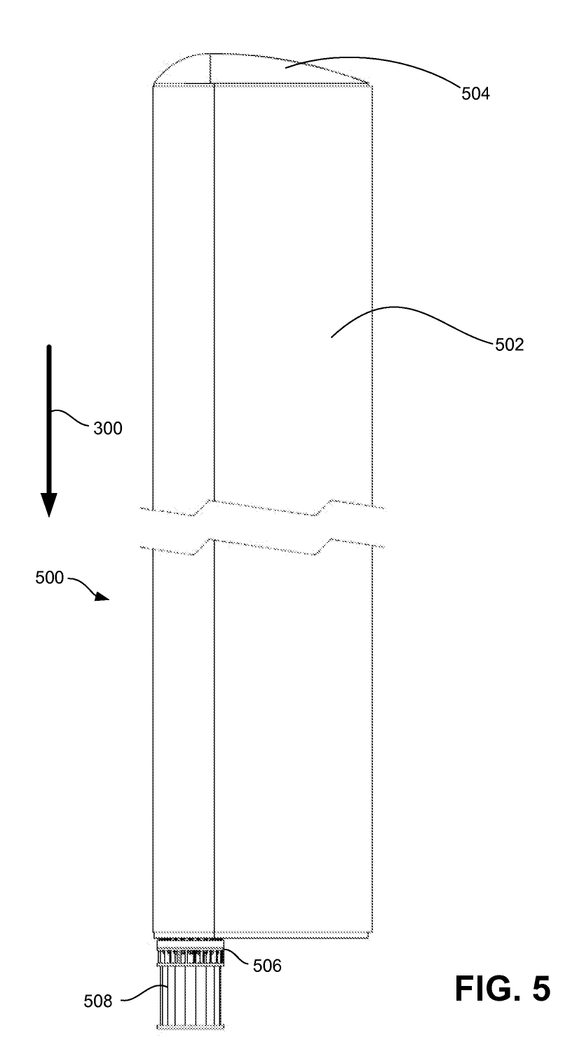

FIG. 5 illustrates a side elevation view of an aerodynamic monopole 100, according to embodiments of the present invention. The aerodynamic monopole 100 may include a top cap 504 for additional drag reduction, according to embodiments of the present invention. According to some embodiments of the present invention, the aerodynamic shell structure 502 is coupled to a shaft 508 by a bearing assembly 506, and rotates on the bearing assembly 506.

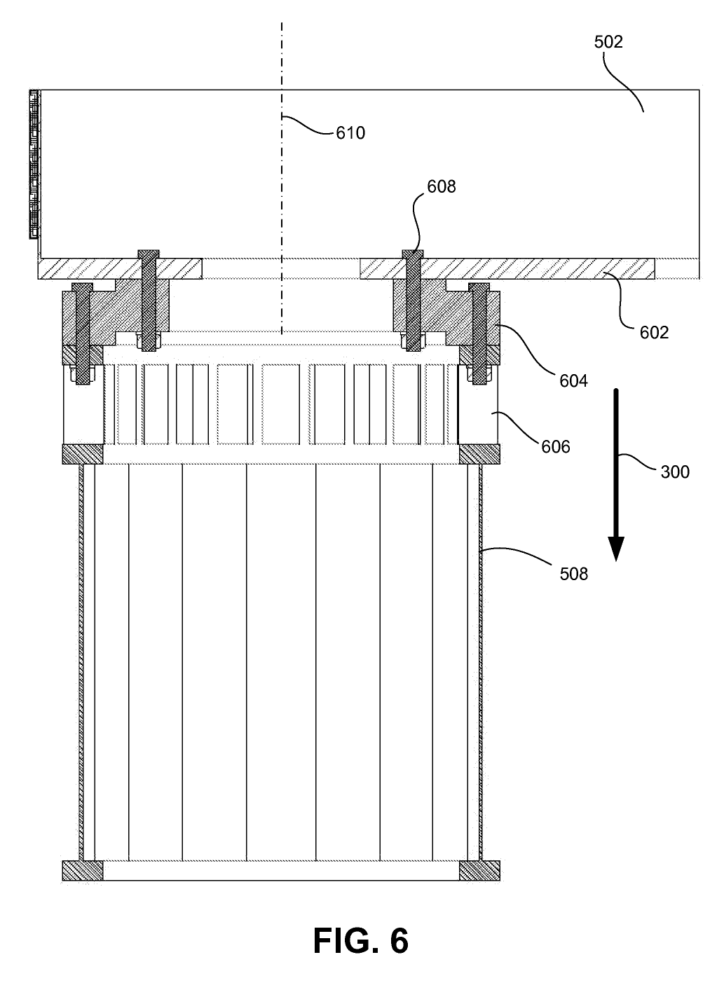

FIG. 6 illustrates an enlarged partial cross sectional view of the aerodynamic shell monopole 100 of FIG. 5, according to embodiments of the present invention. A bearing assembly 604 may be coupled to the bottom 602 of the aerodynamic shell structure 502, according to embodiments of the present invention. Bearing assembly 604 may be bolted to bottom 602 via bolts 608, according to embodiments of the present invention. Bearing assembly 604 may also be coupled to a fixed base connection 606, according to embodiments of the present invention. Rotational bearing assembly 604 bears the horizontal and axial loads of the aerodynamic shell structure 502 and permits the aerodynamic shell structure 502 to rotate about an axial centerline 610 of the bearing assembly 604, according to embodiments of the present invention. The aerodynamic shell structure 502 and bearing assembly 604 rotate with respect to the axial centerline 610, according to embodiments of the present invention. Bearing 604 may be a turntable-type bearing, similar to the bearings used in construction cranes or in the rotors of large wind turbines. A Kaydon 390 Series turntable bearing assembly by Kaydon Bearings may be used as bearing 604, according to embodiments of the present invention.

FIG. 7 illustrates a geometrical configuration for an outer perimeter 704 of an outer surface of an aerodynamic shell structure 102, 502 according to embodiments of the present invention. The aerodynamic shell structure rotates about vertical axis 708, according to embodiments of the present invention. The geometrical configuration for the outer perimeter 704 includes a leading edge 304 and a trailing edge 702, according to embodiments of the present invention. Chord 706 is a straight line connecting the leading edge 304 with the trailing edge 702. According to some embodiments of the present invention, the outer perimeter 704 is an airfoil shape. According to embodiments of the present invention, the aerodynamic shape of the outer perimeter 704 permits air to flow over the shell 102 with less drag; for example, the aerodynamic shape of the outer perimeter 704 permits wind to flow over the monopole shell 102 in an attached flow at normal, or all, wind speeds, instead of in a flow pattern that results in unattached flow or swirling, for example. The location of the vertical axis 708 along the chord 706 may depend upon the final shape of the aerodynamic shell structure 704, and may be used to improve yaw of the shell. If the vertical axis 708 is closer toward the leading edge 304 from the aerodynamic center (along the chord 706), the aerodynamic shell will be more responsive with the leading edge 304 staying into the wind. If the vertical axis 708 is placed along the chord 706 behind the aerodynamic center, the aerodynamic structure 704 will be less responsive, reducing yaw.

According to some embodiments of the present invention, the chord 706 length L is longer than the width W of the outer perimeter 704, where the width W is the maximum dimension of the outer perimeter 704 measured in a direction that is orthogonal to the chord 706 and the vertical axis represented by circles 708 (where the vertical axis 708 extends in a direction orthogonal to the plane of the view of FIG. 7). As illustrated in FIG. 7, the distance along the outer perimeter 704 between the leading edge 304 and the trailing edge 702 is larger than the chord 706 length, according to embodiments of the present invention. FIG. 7 also illustrates an outer perimeter 704 having a continuous curvature along the outer perimeter 704 from the leading edge 304 to the trailing edge 702. The entire outer perimeter 704 includes a continuous curvature except for a single discontinuous edge at the trailing edge 702, according to embodiments of the present invention.

According to some embodiments of the present invention, the shape of the outer perimeter 704 is determined by the following equation:

$$y = \frac{W}{L \times 0.2} \times ( 0.29690 \sqrt{x} - 0.126 x - 0.35160 {x}^{2} + 0.2843 {x}^{3} - 0.10150 {x}^{4} ) \times L \qquad ( Eq . 1 )$$

where x is the position along the chord 706 from leading edge 304 to trailing edge 702, and y is the distance from the chord 706 to the outer perimeter 704 for a given value of x. Although FIG. 7 illustrates an outer perimeter 704 that has bilateral symmetry about the chord 706, other aerodynamic shapes may be used, including aerodynamic shapes that are not bilaterally symmetrical. However, bilateral symmetry may help ensure that the aerodynamic shell 102 reduces wind drag and lift, and orients itself into the prevailing wind. Based on the disclosure provided herein, one of ordinary skill in the art will recognize that numerous other geometries for the aerodynamic shell structure 102 are effective for reducing wind drag when compared to a circular and/or polygonal cross section, according to embodiments of the present invention.

According to some embodiments of the present invention, more than one aerodynamic shell structure 102 may be mounted on a shaft 104. Each such aerodynamic shell structure 102 may rotate independently of the other aerodynamic shell structures 102, according to embodiments of the present invention. Such a characteristic may permit optimized wind drag reduction along the height of a monopole 100 which experiences winds in different directions along its height, according to embodiments of the present invention. Each of multiple aerodynamic shell structures 102 may have separate bearings below each aerodynamic shell structure 102, similar to the bearing arrangement shown in FIG. 6, according to embodiments of the present invention. Alternatively, each of multiple aerodynamic shell structures 102 may be configured to rotate in a synchronized manner, according to embodiments of the present invention. The aerodynamic shell structures 102 may be constructed in modular format, permitting easy addition and/or subtraction and/or substitution of discrete aerodynamic shell structures 102 from a new or existing monopole 100, according to embodiments of the present invention.

According to some embodiments of the present invention, the aerodynamic shell 102 rotates about a shaft 104 that is rigidly fixed to a base structure 106, as illustrated in FIGS. 1-4. According to other embodiments of the present invention, the aerodynamic shell 502 is a self-supporting structure without a supporting shaft, and the bearing assembly 604 coupled to the shell 502 and the shaft 508 bears not only the vertical forces of the shell 502 (e.g. the weight force of the shell), but also the lateral forces (e.g. the wind load) and resulting moments, as illustrated in FIGS. 5 and 6. In some cases, a shaft may be used in combination with a shell 502 similar to that illustrated in FIGS. 5 and 6, as an additional support and/or as a backup support for the monopole shell 502.

According to some embodiments of the present invention, the aerodynamic shell structure 102 has the properties of being the main structural member, transparent to radio-frequency radiation, with the internal monopole 104 acting as the amplitude modulation (AM) device, with an insulator encased in the aerodynamic shell structure 102, according to embodiments of the present invention. According to other embodiments of the present invention, antennae 202 are mounted within the aerodynamic shell structure 102. According to some embodiments of the present invention, a cross-sectional aerodynamic shell outer surface 704 remains constant in shape and dimension from the base 106 up to the top of the monopole 100. According to other embodiments of the present invention, the cross-sectional aerodynamic shell outer surface 704 changes in shape and/or decreases in dimensional scale from the base 106 up to the top of the aerodynamic monopole 100. According to some embodiments of the present invention, the aerodynamic-shaped outer surface 704 has a coefficient of drag of less than 0.1, such as, for example, a coefficient of drag of approximately 0.05, as compared with the coefficient of drag of a perfectly circular cross section of 1.05, or the coefficient of drag of an octagonal cross section of up to 1.2. According to some embodiments of the present invention, a rotating shell 102 may be suitable for AM antenna applications, while a fixed shell 102 that does not rotate may be used for directional antenna applications such as cellular. The aerodynamic shell 102, 502 or sections thereof may be made of RF transparent materials, such that omnidirectional radiating elements can be encapsulated in such shells 102, 502 or may be a part of such structures, which may be well suited for top elements or for pylon applications using omnidirectional or collinear antennae, according to embodiments of the present invention.

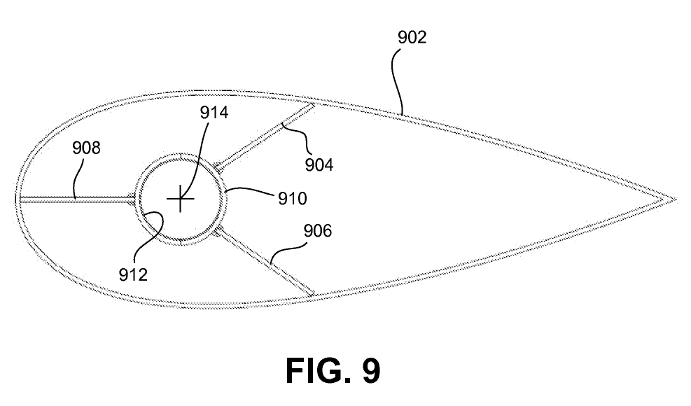

FIG. 8 illustrates a cross-sectional view of an aerodynamic monopole shell 802 with an enlarged partial cross-sectional view 804, according to embodiments of the present invention. The aerodynamic shell includes an inner layer 806 of fiberglass, an outer layer 808 of fiberglass, with an intermediate or core layer 810 of foam, according to embodiments of the present invention. The fiberglass layers 806, 808 may include a fiberglass with a biaxial weave, for example a biaxial weave at a forty-five degree angle for better stress transfer. The monopole shell 802 may include more or less layers, and/or may include one or more layers made of different materials, with or without a foam core, according to embodiments of the present invention.

FIG. 9 illustrates a cross-sectional view of a section of an aerodynamic monopole shell 902 having a shaft 104 interface assembly. The monopole shell 902 is configured to rotate about vertical axis 914. The shaft 104 interface assembly includes front 912 and rear 910 shaft interface plates (which may also be a single shaft sleeve), as well as rear support braces 904, 906 coupling the shaft 104 interface assembly with the inside perimeter of the shell 902 and a front support brace 908 coupling the shaft 104 interface assembly with the inside perimeter of the shell 902 near the leading edge, according to embodiments of the present invention. More or less support braces may be used, and more or less or different support brace 904, 906, 908 placements and/or configurations may be used, according to embodiments of the present invention. According to some embodiments of the present invention, the shaft 104 interface assembly and support braces may be used in the monopole 100 embodiments illustrated in FIGS. 1-4. The support braces and/or shaft 104 interface structure of FIG. 9 may be used along the entire length of the monopole shell 902 and/or may be used at discrete heights or portions along the vertical axis of the monopole shell 902, such as, for example, every ten to twenty feet, according to embodiments of the present invention.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A tower comprising:
a monopole shell having a vertical axis, the vertical axis substantially aligned with a gravitational force, wherein at least a portion of the monopole shell along the vertical axis has a substantially uniform cross sectional shape, wherein the cross sectional shape includes an outer perimeter, wherein the outer perimeter has an aerodynamic shape, wherein the aerodynamic shape comprises a leading edge and a trailing edge, wherein a chord between the leading edge and the trailing edge is shorter than a distance along the outer perimeter between the leading edge and the trailing edge, and wherein a maximum dimension of the outer perimeter measured orthogonally to the chord and the vertical axis is shorter than the chord; and
a base, wherein the monopole shell rotates about the vertical axis with respect to the base.

2. The tower of claim 1, wherein the outer perimeter is bilaterally symmetrical about the chord.

3. The tower of claim 1, further comprising a shaft coupled with the base, the shaft having a central axis, wherein the vertical axis is substantially aligned with the central axis, and wherein the monopole shell rotates about the shaft.

4. The tower of claim 1, further comprising a bearing coupled to the monopole shell and to the base, the bearing having a central axis, wherein the vertical axis is substantially aligned with the central axis, and wherein the monopole shell rotates about the bearing.

5. The tower of claim 1, further comprising a ladder inside of the monopole shell.

6. The tower of claim 1, further comprising an antenna inside of the monopole shell.

7. The tower of claim 6, further comprising:
a hollow shaft coupled with the base; and
an antenna wire, wherein the hollow shaft comprises a central axis, wherein the vertical axis is substantially aligned with the central axis, wherein the monopole shell rotates about the hollow shaft, and wherein the antenna wire is connected with the antenna and extends at least partially inside of the hollow shaft.

8. The tower of claim 7, wherein the antenna is mounted to the hollow shaft.

9. The tower of claim 1, wherein the outer perimeter has a coefficient of drag of less than 0.1.

10. The tower of claim 9, wherein the outer perimeter has a coefficient of drag of approximately 0.05.

11. A tower comprising:
a monopole shell having a vertical axis, the vertical axis substantially aligned with a gravitational force, wherein at least a portion of the monopole shell has an aerodynamic shape, wherein an outer perimeter of the aerodynamic shape comprises a leading edge and a trailing edge, wherein a chord between the leading edge and the trailing edge is shorter than a distance along the outer perimeter between the leading edge and the trailing edge, and wherein a maximum dimension of the outer perimeter measured orthogonally to the chord and the vertical axis is shorter than the chord; and
a base, wherein the monopole shell rotates about the vertical axis with respect to the base.

12. The tower of claim 11, wherein the outer perimeter is bilaterally symmetrical about the chord.

13. The tower of claim 11, further comprising a shaft coupled with the base, wherein the monopole shell rotates about the shaft.

14. The tower of claim 11, further comprising a bearing coupled to the monopole shell and to the base, the bearing having a central axis, wherein the vertical axis is substantially aligned with the central axis, and wherein the monopole shell rotates about the bearing.

15. The tower of claim 11, further comprising a ladder inside of the monopole shell.

16. The tower of claim 11, further comprising an antenna inside of the monopole shell.

17. The tower of claim 16, wherein the antenna is mounted to the hollow shaft.

18. The tower of claim 11, wherein the outer perimeter has a coefficient of drag of less than 0.1.

19. The tower of claim 18, wherein the outer perimeter has a coefficient of drag of approximately 0.05.
